(19) United States
(12) Patent Application Publication
(10) Pub. No.: US 2004/0257497 A1
(43) Pub. Date: Dec. 23, 2004

(54) Super-twist nematic liquid crystal display using thin crystal film polarizer

(76) Inventors: Michael V. Paukshto, Foster City, CA (US); Serguei P. Palto, Moscow (RU); Louis D. Silverstein, Scottsdale, AZ (US)

Correspondence Address: DORSEY & WHITNEY LLP, INTELLECTUAL PROPERTY DEPARTMENT, 4 EMBARCADERO CENTER, SUITE 3400, SAN FRANCISCO, CA, 94111, US

(21) Appl. No.: 10/465,067

(22) Filed: Jun. 18, 2003

(51) Int. Cl. G02F 1/1335

(52) U.S. Cl. 349/98

(57) ABSTRACT

A simple, reliable and cost-effective super-twisted nematic liquid crystal display is disclosed. The liquid crystal display is suitable for application in all portable electronic devices due to the reliable and simple design employing a thin crystal film polarizer and is particularly suitable for outdoor display applications due to its increased environmental robustness. The thin crystal film polarizer also increases the viewing characteristics of the liquid crystal display and provides additional advantages. The disclosed liquid crystal display includes a front and rear polarizer and a super-twisted nematic liquid crystal layer, wherein the liquid crystal layer has a twist angle from about 230° to about 250°. The front and rear transmission axes of the polarizers are angularly displaced by about 70° to about 86° relative to each other.

### FIELD OF THE INVENTION

The present invention relates to the field of liquid crystal displays (LCDs).

### BACKGROUND

A liquid crystal display consists of a number of layers modulating the intensity and color characteristics of light emitted either from a light source incorporated into the display device or from an external light source. When a lighting system is placed on the side of the display opposite to a viewer, it is called a backlighting system. Liquid crystal displays can be of either reflective or transmissive type. A reflective liquid crystal display has a reflecting layer. Light enters a reflective LCD and leaves it on the same (front) side upon reflection from the reflecting layer. Therefore, reflective LCDs are capable of using ambient light sources.

In a transmissive liquid crystal display, light from a backlighting system enters the layers of the device from the rear side and leaves the device on the side of the viewer. Sometimes, a semitransparent reflective layer is used in order to obtain a combination of transmissive and reflective properties that result in a transflective liquid crystal display.

The existing liquid crystal display technologies have a number of shortcomings in outdoor applications. First, the polarizers employed in conventional liquid crystal displays are usually external polarizers placed outside of the cell. The location of the external polarizers renders the polarizers unstable with respect to environmental factors such as moisture, ultra-violet light exposure, scratches, etc. Therefore, liquid crystal displays with external polarizers used in outdoors often require the use of additional protective layers, which increases the cost and complicates the manufacturing process.

Most low-cost liquid crystal displays offering medium to high information content are of the super-twisted nematic (STN) type. The twist angle of STN liquid crystal is in the range from 200° to 270°, preferably from 230° to 250°. The large twist angle provides a very steep dependence of the optical reflection (or transmission) of the liquid crystal display on applied voltage. This in turn enables the whole STN LCD to exhibit tremendous sensitivity in the transition between ON and OFF states. As a result, the transition of a super-twisted nematic liquid crystal display from OFF to ON state requires a relatively small change of applied voltage. This property makes the displays potentially capable of achieving high multiplexing rates.

The disadvantages of conventional super-twisted nematic liquid crystal displays include residual birefringence in ON state of the liquid crystal and narrow viewing angle. The residual birefringence results in low contrast of the display and produces color (green-yellow) appearance in the display background.

For super-twisted nematic liquid crystal displays, the enhancement of contrast and brightness, the widening of viewing angle, and the improvement of color characteristics often involve the use of retardation layers (retarders) of various kinds. Retarders can improve image quality of the display, but the use of them is undesirable for low-cost monochromic displays because it complicates the manufacturing process, the design of the display, and increases the cost. Therefore, a simple, reliable and cost-effective monochromatic display should include a minimal number of layers required to produce the image. Adequate viewing characteristics should be provided with an accurate selection of basic liquid crystal display parameters, such as the angle between the transmission axes of polarizers, the angle between rubbing directions of alignment layers, the twist angle and birefringence of the liquid crystal etc. Moreover, the requirements for simple displays for outdoor applications typically place emphasis on simplicity, environmental robustness and low cost instead of exceptional image quality and aesthetics.

U.S. Pat. No. 5,550,660 discloses a liquid crystal device. Despite careful selection of the angles between the transmission axes of polarizers and rubbing directions of liquid crystal alignment layers, the disclosed device has to use a neutral color backlighting system and spectral polarizing means. This disadvantage complicates the fabrication technology and the design of the device.

### SUMMARY OF THE INVENTION

The disclosed invention provides a monochrome liquid crystal display suitable for displaying images with high multiplexing rates and relatively high contrast ratio and brightness. The disclosed invention also provides a cost-effective, reliable and simple liquid crystal display suitable for outdoor applications, stable with respect to potentially degrading environmental factors such as moisture, ultra-violet radiation, and physical scratch. The disclosed invention further provides a liquid crystal display manufactured from easily accessible materials using conventional methods and technologies. The disclosed invention also provides a liquid crystal display with integral polarizers made of thin crystal films.

In one embodiment, the liquid crystal display of the invention comprises a front and rear polarizer. The transmission axis of the front polarizer is angularly displaced from 2° to 10° with respect to a predetermined reference axis, and the transmission axis of the rear polarizer is angularly displaced from 80° to 88° with respect to the predetermined reference axis. A super-twist nematic liquid crystal layer is positioned between the front and rear polarizers and characterized by a director twist angle in the range from 230° to 250°. A front and rear alignment layer are provided for aligning the super-twist nematic liquid crystal. The alignment direction of the front alignment layer is angularly displaced from 140° to 160° with respect to the predetermined reference axis, and the alignment direction of the rear alignment layer is angularly displaced from −140° to −160° with respect to the predetermined reference axis. At least one polarizer is a thin crystal film polarizer of negative birefringence.

In another embodiment, the liquid crystal display of the invention comprises a front polarizer and rear polarizer. The transmission axis of the front polarizer is angularly displaced from 92° to 100° with respect to a predetermined reference axis, and the transmission axis of the rear polarizer is angularly displaced from 80° to 88° with respect to the predetermined reference axis. A super-twist nematic liquid crystal layer is positioned between the polarizers and characterized by a director twist angle in the range from 230° to 250°. A front and rear alignment layer are provided for aligning the super-twisted nematic liquid crystal. The alignment direction of the front alignment layer is angularly displaced from 140° to 160° with respect to the predetermined reference axis, and the alignment direction of the rear alignment layer is angularly displaced from −140° to −160° with respect to the predetermined reference axis. At least one polarizer is a thin crystal film polarizer of negative birefringence.

### BRIEF DESCRIPTION OF THE DRAWINGS

Other objects and advantages of the present invention will become apparent upon reading the detailed description of the invention and the appended claims provided below, and upon reference to the drawings, in which:

FIG. 1 is a schematic showing the layers of the disclosed liquid crystal display.

FIG. 2 shows the mutual orientation of the optical axes of the polarizers and alignment layers in the disclosed normally white liquid crystal display.

FIG. 2a shows the mutual orientation of the optical axes of the polarizers and alignment layers in the disclosed normally black liquid crystal display.

FIG. 3 is a schematic of the disclosed liquid crystal display with a backlighting system.

FIG. 4 is a schematic of the disclosed liquid crystal display with a reflective layer.

FIG. 5 is a schematic of the super-twist nematic liquid crystal display with one internal polarizer made of a thin crystal film.

FIG. 6 is a schematic showing the layers of the disclosed liquid crystal display according to one embodiment of the invention.

FIG. 7 is a CIE 1976 color diagram for the disclosed liquid crystal display according to one embodiment of the invention.

FIG. 8 is an iso-contrast polar plot for the disclosed liquid crystal display according to one embodiment of the invention.

### DETAIL DESCRIPTION OF THE INVENTION

The disclosed liquid crystal display comprises a front substrate, a front polarizer, a rear polarizer and a rear substrate. A liquid crystal layer with front and rear alignment layers and front and rear electrodes is sandwiched between the front and rear polarizers and between the front and rear substrates. The twist angle of the liquid crystal layer is from about 230° up to about 250°.

The typical undesirable attributes of super-twisted nematic liquid crystal displays without compensatory retarders include low contrast ratio and non-achromatic nature of images, which are caused by the residual birefringence of the liquid crystal. A compensatory retardation film or a birefringent polarizer having the functions of both retardation and polarization helps overcome these problems. Further, the use of birefringent polarizer can simplify the design of the display and reduce the cost of the display. Since most available liquid crystal materials are positively birefringent, a negatively birefringent retardation layer can generally compensate the residual birefringence of the liquid crystal. Therefore, a polarizer with negative birefringence is used in the disclosed invention to accomplish the described requirements.

The use of such a combined polarizer and retarder requires a specific design of the display, especially with respect to the mutual alignment of the polarizer transmission axes and the alignment directions of the liquid crystal optic axes at the boundaries of the liquid crystal and the alignment layers. In one embodiment, the front polarizer is placed between the front substrate and the liquid crystal layer. The front polarizer has a transmission axis angularly displaced from 2° to 10° with respect to a fixed reference axis. The rear polarizer has transmission axis angularly displaced from 80° to 88° with respect to the reference axis. The front alignment layer is conditioned so that the alignment direction of the surface-contacting directors of the liquid crystal molecules is angularly displaced from 140° to 160° with respect to the reference axis, and the rear alignment layer is conditioned so that the alignment direction of the surface-contacting directors of the liquid crystal molecules is angularly displaced from −140° to −160° with respect to the reference axis. Hereinafter the alignment direction attributed to the alignment layer means the alignment direction of the surface-contacting directors of the liquid crystal molecules. This design provides a normally white display, i.e., the display having a bright background when a zero voltage is applied. At least one of the front and rear polarizers is made of a thin crystal film material and possesses negative birefringence.

In another embodiment, a normally black display is provided. The front polarizer in the normally black display has a transmission axis angularly displaced from 92° to 100° with respect to a fixed reference axis. The rear polarizer has a transmission axis angularly displaced from 80° to 88° with respect to the reference axis. The super-twisted nematic liquid crystal layer is positioned between the polarizers and characterized by a director twist angle in the range from 230° to 250°. A front alignment layer is conditioned so that the alignment direction of the surface-contacting directors of the liquid crystal molecules is angularly displaced from 140° to 160° with respect to the reference axis. A rear alignment layer is conditioned so that the alignment direction of the surface-contacting directors of the liquid crystal molecules is angularly displaced from −140° to −160° with respect to the reference axis. At least one of the front and rear polarizers is made of thin crystal film materials and possesses negative birefringence.

The super-twisted nematic liquid crystal layer with a twist angle from about 230° up to about 250° is the most common way to obtain a liquid crystal display with a high multiplexing level. Most low-cost liquid crystal displays are of the super-twisted nematic type, and the most widely used twist angle is about 240°. The front polarizer placed between the front substrate and the liquid crystal layer is protected from the atmospheric moisture, scratches, etc in a simple and inexpensive way. Preferably the rear polarizer is placed between the rear substrate and the liquid crystal layer and protected from environmental factors and mechanical damage, for example, by front layers.

The use of thin crystal films as the polarizer materials is important for the disclosed liquid crystal display. The thin crystal film can be easily coated on a multitude of surfaces, including glass, transparent plastic, indium-tin oxide electrode material, etc. Hence the thin crystal film polarizer can be easily placed between the substrates. The small thickness (less than one micron) and the large viewing angle characteristics of the thin crystal film increase the angular contrast performance of the disclosed liquid crystal display. Also the thin crystal films possess negative birefringence which is highly desirable in the disclosed invention. The thin crystal film polarizers also possess high temperature and ultra-violet stability important for outdoor display applications. The good dichroic ratio of the thin crystal film polarizers combined with the ability to easily adjust the polarizer coating thickness for particular applications help achieve a high contrast ratio of the liquid crystal display.

The exceptional properties of the thin crystal film polarizers (for instance, see Y. Bobrov et al., Thin Film Polarizers for Liquid Crystal Displays, Proceedings of SPIE, vol. 4511, 2001, pp. 133-140)—the small thickness, the thermal stability of the film and of the film optical properties, the possibility of disposition on a variety of surfaces, the high dichroic ratio, etc.—are associated with the technology of thin crystal film manufacturing. The technology was developed by the Optiva Inc., South San Francisco, Calif., USA.

U.S. Pat. No. 6,399,166 describes a thin crystal film, the entire disclosure of which is incorporated herein by reference.

The thin crystal film is based on dichroic dye materials, or on the mixture of dichroic dyes. At least one organic compound is used whose formula contains at least one ionogenic group, providing solubility in polar solvents, and/or at least one nonionogenic group, providing solubility in nonpolar solvents, and/or at least one counter-ion that either remains or does not remain in the structure of the molecule during preparation of the material. On dissolving such an organic compound in an appropriate solvent, a colloid system is formed (a lyotropic liquid crystal), in which molecules are associated in supramolecular complexes being kinetical units of the system (WO 01/63346). A liquid crystalline phase is a pre-ordered state of the system, which determines the initial anisotropy of the material. In the process of alignment of supramolecules and in the course of subsequent removal of the solvent, a solid crystalline film possessing optical anisotropy (in particular, dichroism) is formed.

It is also possible to mix colloid systems (in this case, mixed supramolecules will be formed in a solution) to obtain crystalline films with intermediate optical characteristics. In optically anisotropic dichroic crystalline films obtained from mixtures of colloid solutions, absorption and refraction may be characterized by different values in the ranges determined by initial components. Mixing different colloid systems with the formation of mixed supramolecules is possible due to the coincidence of one of molecular dimensions (interplanar distances) of various organic compounds (3.4±0.3 Å).

The surfaces, on which the crystalline films are deposited, may be subject to additional treatment to provide uniform wettability (to provide for hydrophilic properties of the surface). This may be mechanical treatment, annealing, and mechanochemical treatment. Similar treatment can also facilitate decreasing the film thickness and increasing the degree of molecular ordering. Furthermore, to increase the ordering in the film at the surface of a substrate, aligning anisotropic structures can be formed by mechanical treatment of the substrate surface.

The enhanced contrast and brightness of the disclosed liquid crystal display is obtained by using the mutual orientation of the transmission axes of the polarizers and alignment directions of the alignment layers and by the negative birefringence of the polarizers. The negative birefringence of the polarizers corrects the elipticity of the polarization arising from the residual birefringence of the super-twisted nematic liquid crystal layer. The described mutual orientation of the transmission axes of the polarizers and the liquid crystal alignment layers can enhance image contrast and provide the display with the capability of working in both reflective and transmissive modes.

Therefore, the described liquid crystal display can be provided with an integral backlighting system. The incorporation of a backlighting system in the device provides a transmissive liquid crystal display. The addition of a reflective layer to the rear side of the device provides a reflective liquid crystal display. The use of a semitransparent reflective layer attached to the rear side of the device provides a transflective liquid crystal display.

The light interference in the layers of the liquid crystal display usually decreases the contrast ratio and creates undesired coloring of the background. The use of a diffusive reflective layer is one way to reduce the effects of multiple reflections along the direction of viewing thereby increasing the contrast ratio. The use of a specular reflective layer can provide for a high reflected brightness of the liquid crystal display. In one embodiment of the disclosed invention, a diffusive light-scattering material is introduced into any layer of the liquid crystal display.

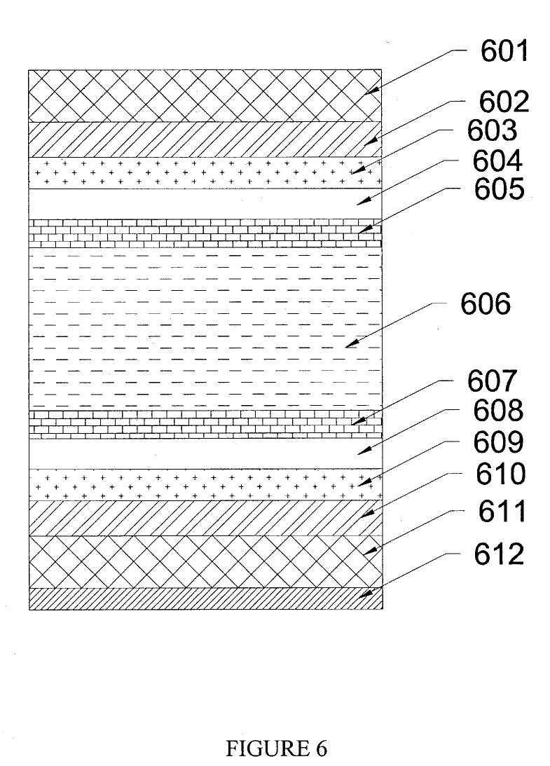

The disclosed invention was modeled using a structure shown in FIG. 6 and described below. The modeled structure included a first glass substrate, first indium-tin oxide (ITO) electrode, a planarization layer, a first thin crystal film (TCF) polarizer layer, a first alignment layer, a liquid crystal layer, a second alignment layer, a second TCF polarizer layer, a second planarization layer, a second ITO electrode, a second glass substrate, and a reflective layer. Therefore, the modeled structure was of a reflective type. Both polarizer layers were made of the thin crystal film. The left-hand twist angle of the directors in the liquid crystal layer was 240°. The planarization layers was included to provide a barrier between the ITO and TCF layers and a smooth, flat interface for the coating of the TCF layer. Detailed parameters of the employed materials are presented in Table 1.

TABLE 1
Basic characteristics of the materials

| Material (layer) | Type | Thickness | Refractive Indices |
|---|---|---|---|
| ITO (electrode) | 20 ohm | 130 nm | 1.85 at 633 nm |
| SiO2 (planarization) | | 70-80 nm | 1.57 at 633 nm |
| P1 (alignment) | SE3210 Nissan | 40 nm | 1.68 |
| First type LC | MLC-6806-000; 4 deg. pre-tilt; 6.5 micron | | |
| | cell gap; rms voltage of 1.4-1.6 V, 1/48 | | |
| | duty cycle | | |
| Glass (substrate) | | 0.7 mm | 1.5 |

| | | |
|---|---|---|
| TCF (polarizer) | N015.00 | H0 = 32.5, H90 = 6.1 |
| | | (reference thickness |
| | | of Standard N015 350 nm) |

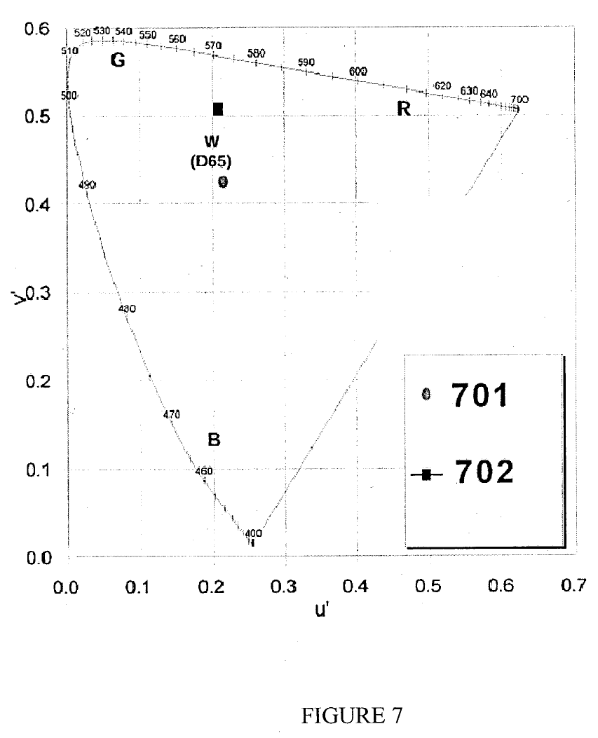

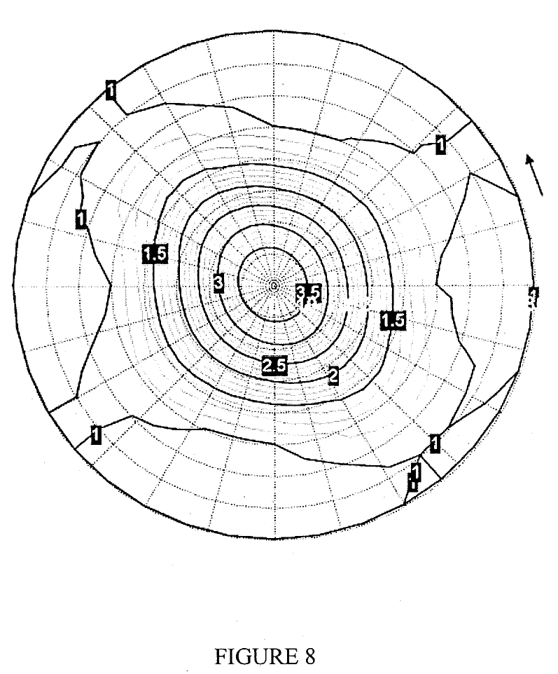

The main performance characteristics of the design are presented in FIGS. 7 and 8. The amplitude of the driving voltage is about 5.7 V. The contrast ratio is about 4, which represents subliminal value in contrast performance because it is based on specular reflectance. The use of diffusive reflectance can make the contrast ratio substantially higher.

The present invention will now be described in more detail with reference to the accompanying drawings.

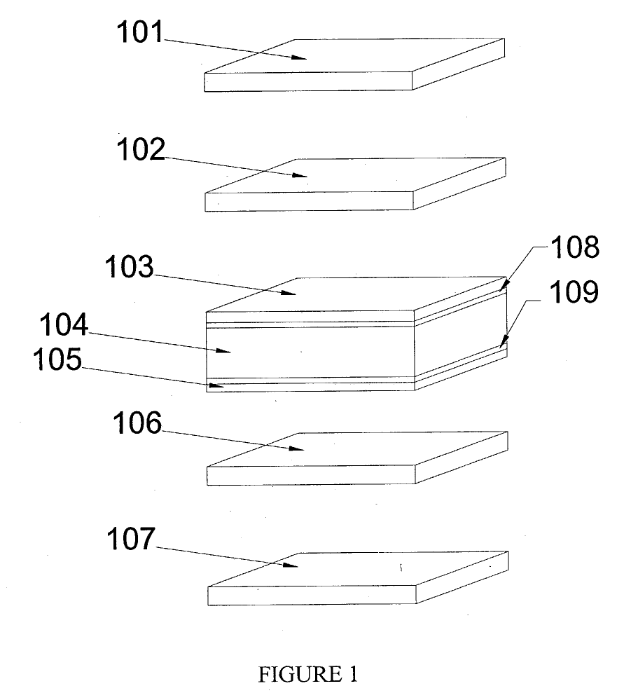

As shown in FIG. 1, the disclosed liquid crystal display comprises the following layers: a front polarizer 101, a front substrate layer 102, front 103 and rear 105 transparent electrodes, front 108 and rear 109 alignment layers, a rear substrate 106, a rear polarizer 107, and a liquid crystal layer 104. The front substrate layer 102 is arranged behind the front polarizer 101. The front transparent electrode 103 is preferably made from indium-tin oxide (ITO) and is set behind the substrate layer 102. The front alignment layer 108 lies behind the transparent electrode 103. The front 108 and rear 109 alignment layers sandwich the liquid crystal layer 104. The rear transparent electrode 105 is arranged behind the rear alignment layer 109, the rear substrate 106 is positioned behind the transparent electrode 105, and the rear polarizer 107 is positioned behind the rear substrate 106. In this Figure, the polarizer layers 101 and 107 are placed on the outer surfaces of the transparent substrates 102 and 106.

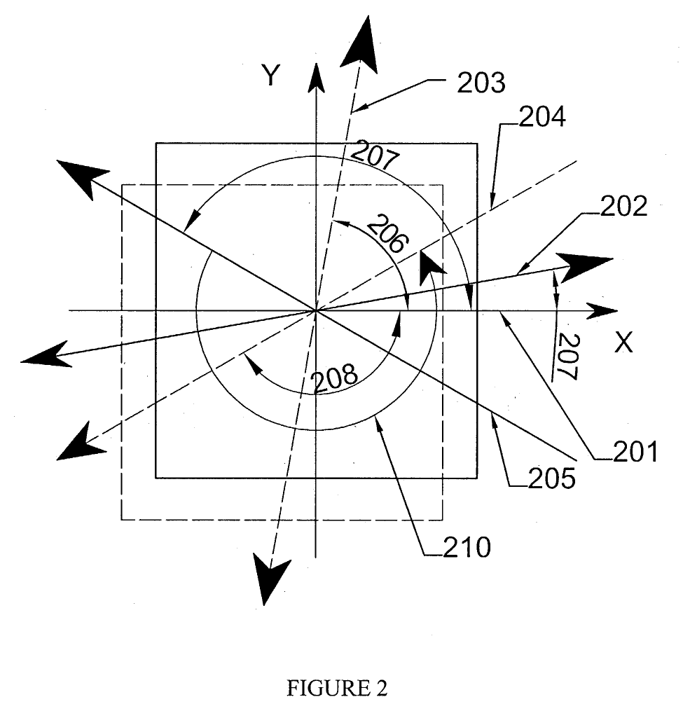

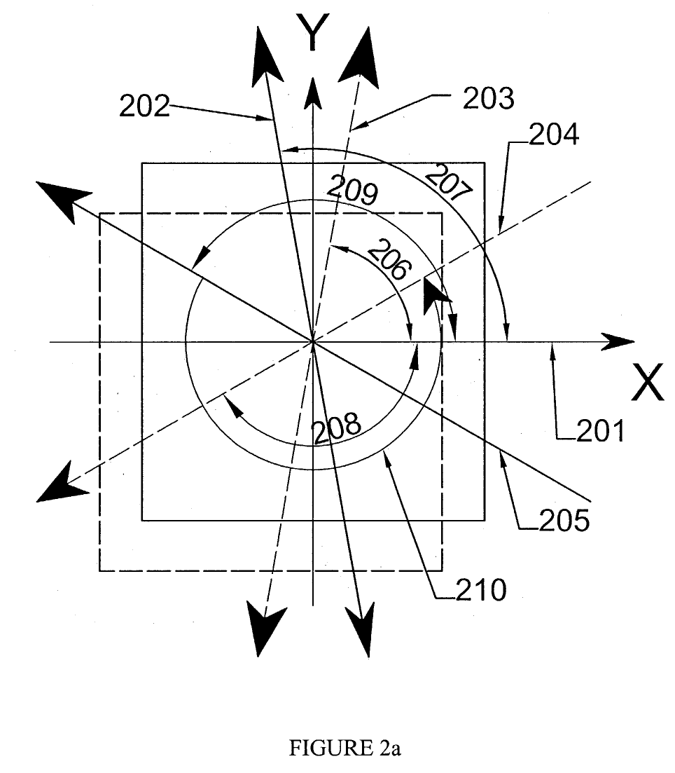

FIG. 2 shows the mutual orientation of the optical axes of the polarizers and alignment layers in the disclosed normally white liquid crystal display. In FIG. 2, the embodiment of the disclosed invention is presented as being viewed from the front of the display. The orientation of the axes of the polarizer layers and alignment layers are given relative to the X-axis 201. The corresponding Y axis is directed as shown in FIG. 2, and the Z axis is directed to the viewer, i.e., from the rear to the front side of the display. The transmission axis 202 of the front polarizer makes an angle 207 from 2° to 10° with respect to the reference axis 201, the transmission axis 203 of the rear polarizer makes an angle 206 from 80° to 88° with respect to the reference axis 201. The rubbing direction 205 of the front alignment layer makes an angle 207 of 150° with respect to the reference axis 201, and the rubbing direction 204 of the rear alignment layer closest to the second polarizer makes an angle 208 of −150° with respect to the reference axis 201. The axes of the alignment directions are shown with arrows in FIG. 2. The liquid crystal directors undergo a 240° counterclockwise rotation 210 from 150° at the front of the display to −150° at the rear of the display.

FIG. 2a shows the mutual orientation of the optical axes of the polarizer and alignment layers in the disclosed normally black liquid crystal display. In FIG. 2a, the embodiment of the disclosed invention is presented as being viewed from the front of the display. The orientation of the axes of the polarizer layers and the alignment layers are given relative to the X-axis 201. The transmission axis 202 of the front polarizer makes an angle 207 from 92° to 100° with respect to the reference axis 201, the transmission axis 203 of the rear polarizer makes an angle 206 from 80° to 88° with respect to the reference axis 201. The rubbing direction 205 of the front alignment layer makes an angle 209 of 150° with respect to the reference axis 201, and the rubbing direction 204 of the rear alignment layer closest to the second polarizer makes an angle 208 of −150° with respect to the reference axis 201. The axes of the alignment directions are shown with arrows in FIG. 2a. The liquid crystal directors undergo a 240° counterclockwise rotation 210 from 150° at the front of the display to −150° at the rear of the display.

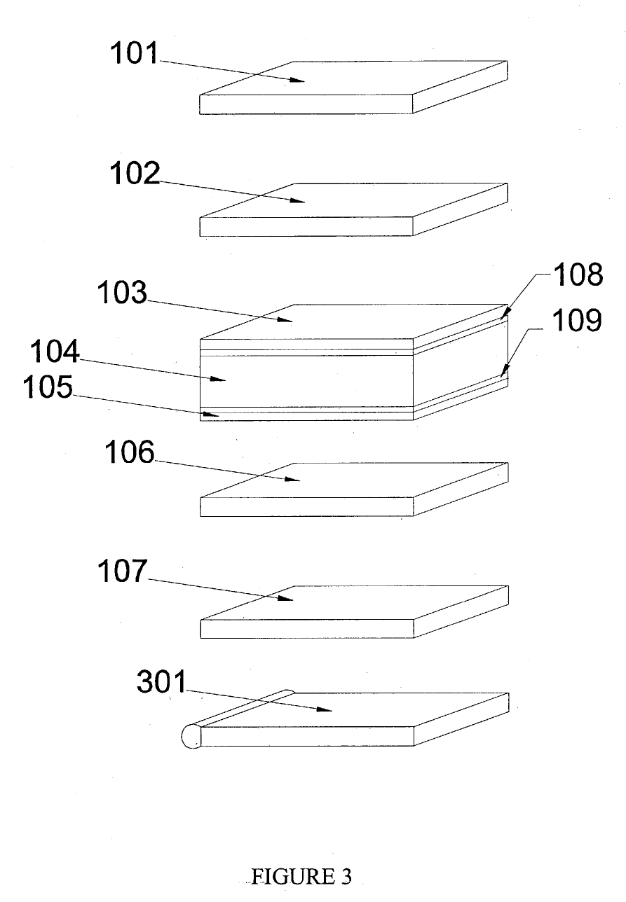

FIG. 3 illustrates an embodiment of the disclosed liquid crystal display having a backlighting system 301. The backlighting system 301 module is fixed on the rear side of the display. The use of the backlighting system makes the transmissive liquid crystal display capable of forming images without ambient light sources.

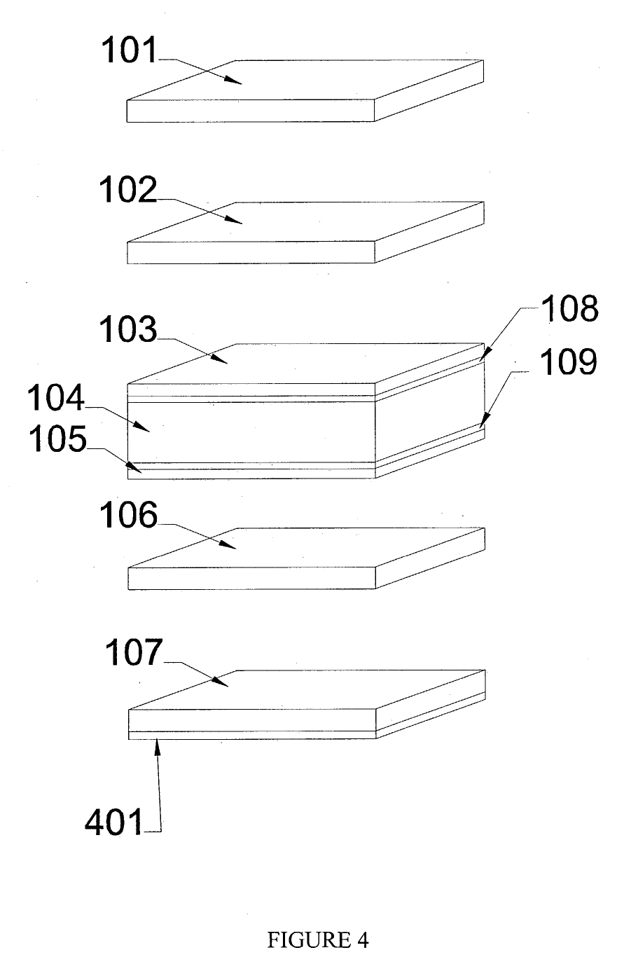

FIG. 4 illustrates an embodiment of the disclosed liquid crystal display having a reflective layer 401. Therefore, this is a liquid crystal display of reflective type. The reflective layer 401 can be either a specular reflective layer or a diffusive reflective layer. The former is helpful in providing for a brighter image, while the latter is capable of minimizing degrading effects of static reflections along the viewing direction, thus giving a higher contrast.

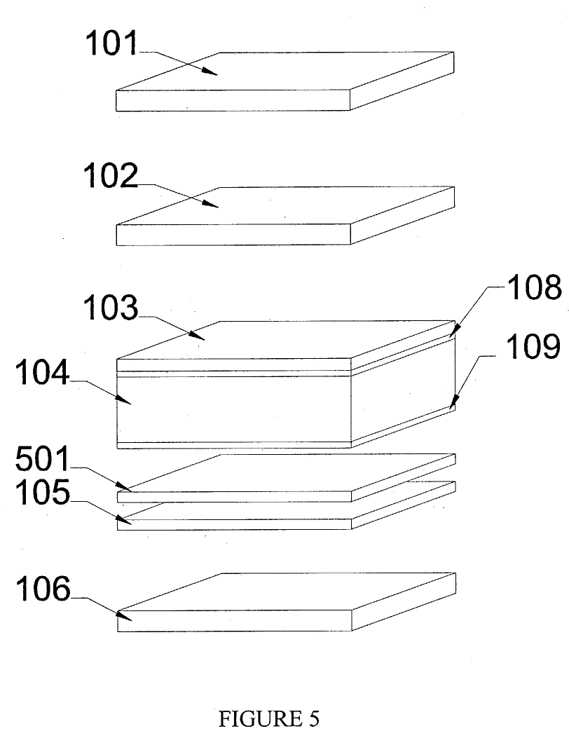

FIG. 5 shows an embodiment of the disclosed liquid crystal display having an internal polarizer 501. This design uses only one internal polarizer layer 501 arranged between ITO electrode 105 and alignment layer 109. The second polarizer of the display is a conventional external polarizer 101. It is possible that both polarizers are internal polarizers.

FIG. 6 illustrates one embodiment of the disclosed invention. The liquid crystal display includes a first transparent glass substrate 601, a first ITO electrode 602, a first planarization layer 603, a first TCF polarizer 604, a first alignment layer 605, a liquid crystal layer 606, a second alignment layer 607, a second TCF polarizer 608, a second planarization layer 609, a second electrode 610, a second transparent glass substrate 611 and a reflective layer 612. The transmission axes of the TCF polarizer layers 604 and 608 and the rubbing directions of the alignment layers 605 and 607 are aligned as shown in FIG. 2. In particular, the angle of the first (front) polarizer transmission axis is from 2° to 10°, and the angle of the second (rear) polarizer transmission axis is from 80° to 88°.

FIG. 7 illustrates one embodiment of the disclosed invention. The CIE 1976 color diagram was obtained for the model of the liquid crystal display disclosed in the invention. Point 701 is the color point of the liquid crystal display in the dark state, and point 702 is the color point of the liquid crystal display in the light state. The D65 standard white point is shown as a point of reference.

FIG. 8 illustrates one embodiment of the disclosed invention. The iso-contrast polar plot was obtained for the model of the liquid crystal display disclosed in the invention. The disclosed liquid crystal display demonstrates a good contrast ratio within a wide range of polar and azimuthal angles. It should be understood that the data in FIG. 8 represents a subliminal value because the specular reflection from the front side is used. The use of a diffusive surface or inexpensive antireflective covering can significantly increase the contrast ratio.

The foregoing descriptions of specific embodiments of the invention have been presented for the purpose of illustration and description. They are not intended to be exhaustive or to limit the invention to the precise forms disclosed, and obviously many modifications, embodiments, and variations are possible in light of the above teaching. It is intended that the scope of the invention be defined by the claims appended hereto and their equivalents.

What is claimed is:

1. A liquid crystal display, comprising
a front polarizer layer, wherein the transmission axis is angularly displaced from 2° to 10° with respect to a predetermined reference axis,
a rear polarizer layer, wherein the transmission axis is angularly displaced from 80° to 88° with respect to the predetermined reference axis,
a super-twist nematic liquid crystal layer positioned between the front and rear polarizers and characterized by a director twist angle in the range from 230° to 250°,
a front alignment layer, wherein the alignment direction is angularly displaced from 140° to 160° with respect to the predetermined reference axis,
a rear alignment layer, wherein the alignment direction is angularly displaced from −140° to −160° with respect to the predetermined, reference axis, and
wherein at least one polarizer is a thin crystal film polarizer of negative birefringence.

2. The liquid crystal display according to claim 1, further comprising a backlighting system positioned on a rear side of the display.

3. The liquid crystal display according to claim 1, further comprising a reflecting layer on the rear side of the display.

4. The liquid crystal display according to claim 3, wherein the reflecting layer has a specular reflection.

5. The liquid crystal display according to claim 3, wherein the reflecting layer has a diffusive reflection.

6. The liquid crystal display according to claim 1, further comprising a transflective layer on the rear side of the display.

7. The liquid crystal display according to claim 6, wherein the transflective layer has a specular reflection.

8. The liquid crystal display according to claim 6, wherein the transflective layer has a diffusive reflection.

9. The liquid crystal display according to claim 1, wherein the thin crystal film polarizer is made from at least one dichroic dye material comprising aromatic rings, and an interplanar distance along the transmission axis is 3.4±0.3 Å.

10. The liquid crystal display according to claim 9, wherein the dichroic dye material is heterocyclic.

11. The liquid crystal display according to claim 9, wherein the dichroic dye is capable of forming a stable lyotropic liquid crystal.

12. The liquid crystal display according to claim 1, further comprising an antireflective or antiglare coating.

13. The liquid crystal display according to claim 1, wherein a diffuse light-scattering material is incorporated into at least one layer.

14. The liquid crystal display according to claim 1, wherein the thickness of the layers is selected in order to provide the maximum interference intensity at the front side of the display for the light within the wavelength region of 530 nm to 580 nm.

15. The liquid crystal display according to claim 1, wherein at least one polarizer layer is placed inside the liquid crystal display.

16. The liquid crystal display according to claim 1, wherein the thin crystal film polarizer additionally functions as a color filter.

17. A liquid crystal display, comprising
a front polarizer, wherein the transmission axis is angularly displaced from 92° to 100° with respect to a predetermined reference axis,
a rear polarizer, wherein the transmission axis is angularly displaced from 80° to 88° with respect to the predetermined reference axis,
a super-twist nematic liquid crystal layer positioned between the polarizers and characterized by a director twist angle in range from 230° to 250°,
a front alignment layer, wherein an alignment direction is angularly displaced from 140° to 160° with respect to the predetermined reference axis,
a rear alignment layer, wherein an alignment direction is angularly displaced from −140° to −160° with respect to the predetermined reference axis, and
wherein at least one polarizer is a thin crystal film polarizer of negative birefringence.

18. The liquid crystal display according to claim 17, further comprising a backlighting system positioned on a rear side of the display.

19. The liquid crystal display according to claim 17, further comprising an additional reflecting layer on the rear side of the display.

20. The liquid crystal display according to claim 19, wherein the reflecting layer has a specular reflection characteristic.

21. The liquid crystal display according to claim 19, wherein the reflecting layer has a diffusive reflection.

22. The liquid crystal display according to claim 18, further comprising a transflective layer on the rear side of the display.

23. The liquid crystal display according to claim 22, wherein the transflective layer has a specular reflection.

24. The liquid crystal display according to claim 22, wherein the transflective layer has a diffusive reflection.

25. The liquid crystal display according to claim 17, wherein the thin crystal film polarizer is made from at least one dichroic dye material comprising aromatic rings, and an interplanar distance along the transmission axis is 3.4±0.3 Å.

26. The liquid crystal display according to claim 25, wherein the dichroic dye material is heterocyclic.

27. The liquid crystal display according to claim 25, wherein the dichroic dye is capable of forming a stable lyotropic liquid crystal.

28. The liquid crystal display according to claim 17, further comprising an antireflective or antiglare coating on the front of the display.

29. The liquid crystal display according to claim 17, wherein a diffuse light-scattering material is incorporated into at least one layer.

30. The liquid crystal display according to claim 17 wherein the thickness of the layers is selected in order to provide the maximum interference intensity at the front side of the display for the light within the wavelength region of 530 nm to 580 nm.

31. The liquid crystal display according to claim 17, wherein at least one polarizer layer is placed inside the liquid crystal display.

32. The liquid crystal display according to claim 17, wherein the thin crystal film polarizer additionally functions as a color filter.
